(19) United States
(12) Patent Application Publication
(10) Pub. No.: US 2010/0285249 A1
(43) Pub. Date: Nov. 11, 2010

(54) WASH-OFF PRESSURE-SENSITIVE LABEL

(75) Inventors: Noel Mitchell, Wuppertal (DE); Tom Saxberg, Tampere (FI)

Correspondence Address: VENABLE LLP, P.O. BOX 34385, WASHINGTON, DC, 20043-9998, US

(73) Assignee: UPM Raflatac, Tampere (FI)

(21) Appl. No.: 12/681,647

(22) PCT Filed: Oct. 6, 2008
(86) PCT No.: PCT/FI2008/050552

§ 371 Date: Jul. 23, 2010

Related U.S. Application Data
(60) Provisional application No. 60/960,609, filed on Oct. 5, 2007.

(51) Int. Cl. B32B 1/02; B32B 27/32; B32B 7/02; B05D 1/36; B32B 37/12

(52) U.S. Cl. 428/35.7; 428/354; 428/213; 427/207.1; 156/278

(57) ABSTRACT

A label including a base film having a front side and a reverse side, and an adhesive layer on the reverse side of the base film. The base film is a co-extruded multilayered film including at least two layers, which are made of different materials and are formed such that the base film formed by the layers has asymmetry. Alternatively, the base film is a multilayered film including at least two layers laminated together, which layers are oriented in different degrees of orientation in at least one direction of the layer. The pressure-sensitive label structures are used for wash-off pressure-sensitive labels for reusable bottles or other containers.

### FIELD OF THE INVENTION

The present invention relates to labels, and more particularly to wash-off pressure-sensitive labels for use on reusable bottles and other containers.

### BACKGROUND OF THE INVENTION

Today, bottles, for example those used in beverage industry, are generally reused or recycled several times. The bottles are washed at each return before refilling, and the labels are detached during the washing of the bottles. In the beverage industry, the washing of bottles and the other containers is generally carried out with a hot washing liquid, such as dilute caustic soda heated to 50 . . . 90° C., without additional mechanical washing means. Paper labels used for the labelling of the reusable bottles are easily removed during such washing process. However, polymeric film based labels precoated with adhesive are increasingly desired for use in the labelling of the reusable bottles and other containers. The polymeric film labels, in contrast to the paper labels, have e.g. a superior wet strength and transparency, and they can be dispensed onto the bottles and other containers in standardised machines, without a need to work with separate adhesives, as for example in the case of the wet-glue paper label. However, it should also be possible to wash off such pressure sensitive film labels with existing washing systems as easily as the paper labels. Because polymeric labels do not possess the water permeability of the paper labels, the polymeric labels have been found to be significantly more difficult to remove completely with the existing washing process.

One solution for a filmic pressure sensitive wash-off construction is described in the patent application WO 00/62273 by Steinbeis:
A release liner, such as a polyester film, is coated with silicone, which is then coated with a pressure-sensitive adhesive and dried under heat in an oven. This adhesive layer is then laminated with a mono- or biaxially oriented heat-shrinkable polyester (PET) or polyvinylchloride film (PVC), in which case the adhesive preferentially transfers to the PVC or PET filmic surface. This construction may or may not be overlaminated with another reverse printed film, such as a polypropylene film. Under the typical washing conditions of 65 . . . 85° C. in an alkaline solution containing 1 to 4% of caustic soda, the base PVC or PET film shrinks severely, causing the whole label to curl, allowing the caustic solution to weaken the adhesive with the result that it detaches from the bottle. The bottles in this case could be typically either of glass or of polyester. The wash-off performance is based on the severe shrinking of the PVC or PET base film which has a non-laminated single material composition.

Other possible alternatives are described in the patent applications of Avery Dennison, WO 2006/076327, and Spear, WO 2006/106309. According to the Spear publication, the construction consists of a silicone coated release liner, on top of which is an adhesive and a polypropylene film. This base construction is then laminated to a reverse-printed polyester film. Due to the differences in the coefficients of thermal expansion between the polypropylene and polyester films, the resulting structure curls under the heat of the washing solution described above, allowing the solution to weaken the adhesive, resulting again in the detachment of the label. Here the wash-off performance is based on the properties of the laminated structure, where the two different material layers have different coefficients of thermal expansion, causing the laminated structure to curl. According to the Avery Dennison publication, the basic film may also consist of two different polymeric layers coextruded into a single film, and said layers having significantly different coefficients of linear thermal expansion.

The major deficiencies of these structures are not only that they are costly and in some cases the use of environmentally unfriendly PVC solutions. These structures also have a density greater than one rendering them unable to be recycled in a normal polyester bottle recycling process. In this case the labelled bottles are crushed into smaller pieces, washed in a hot caustic solution where the label is expected to detach from the polyester and float to the surface of the solution where it is removed, whilst the polyester of the bottle sinks to the bottom of the container. In this way, both label and bottle are separated and recycled.

There is still a need for polymeric based film labels that can not only be easily removed from the glass bottles, but they can also be washed and separated from polyester bottles by using the existing washing process. Ability to use the same washing process also for the new type of labels provides a significant economical advantage for the operator of such a process.

### SUMMARY OF THE INVENTION

The aim of the invention is to provide a novel structure of labels that can be detached from bottles and other containers by using conventional washing processes.

The label according to one embodiment of the invention is characterized in what will be presented in claim 1.

The label according to another embodiment of the invention is characterized in what will be presented in claim 11.

The label according to the invention comprises a base film having a front side and a reverse side and an adhesive layer on the reverse side of the base film. The base film of the label is multilayered.

According to the first embodiment of the invention, the base film is a co-extruded multilayered asymmetric film, i.e. it has been formed by the co-extrusion technique in which all the basic layers of the film are formed substantially simultaneously from melted plastic materials. The base film comprises at least two layers, which layers are composed on the different chemical compositions and the layers are formed in such a way that the base film formed by the layers has asymmetry.

The asymmetry of the base film according to the invention can be achieved in several different ways via altering the thickness of the individual layers and/or the order of the different material layers of the film.

For example, the base film can be formed from only two layers of different materials, i.e. the chemical composition of the materials of the layers is different, each layer having a different thickness. Another possibility is that the base film can comprise three or more layers in such a way that the order of the different material layers in the film provides the required asymmetry. In this case, at least two layers are made of different materials. For example, in a three layer structure, the outmost layers of the base film can be formed of different materials. In this case the thickness of the individual layers may be the same or different. In the three or more layer structures in addition to the order of the different layers, asymmetry can be enhanced by the fact that the individual layers have different thicknesses.

Due to the asymmetrically structured base film, the asymmetry being based on the thickness of the individual layers and/or the order of the different layers of the film, the label detaches from the bottle or other container under the heat of the washing solution as the different behaviour of the layers causes the film to become curled or curved to aid the washing process.

According to the second embodiment of the invention, the multilayered base film of the label comprises at least two layers which are oriented in different degrees of orientation in at least one direction of the layer. Due to the difference in the degrees of orientation, the label detaches from the bottle under the washing conditions. The differently oriented layers may be of same material, i.e. the chemical composition of the materials of the layers is the same.

The base film of the label may be directly printed, or a pre-printed film may be laminated over the base film of the label.

The pressure-sensitive label structures according to the invention are used for wash-off pressure-sensitive labels for reusable bottles or other containers. The reusable article may be a beverage bottle, but it can also be any other reusable container made of glass or polymer.

### DESCRIPTION OF THE DRAWINGS

In the following, some embodiments of the invention will be described in detail. The appended drawings are part of the description. In the drawings,

FIG. 1 shows a cross-sectional view of a web comprising labels of the invention,

FIGS. 2a and 2b show a cross-sectional view of the base film of the label according to the first embodiment of the invention, and

FIGS. 3a and 3b show the base film of the label according to the second embodiment of the invention.

### DETAILED DESCRIPTION OF THE INVENTION

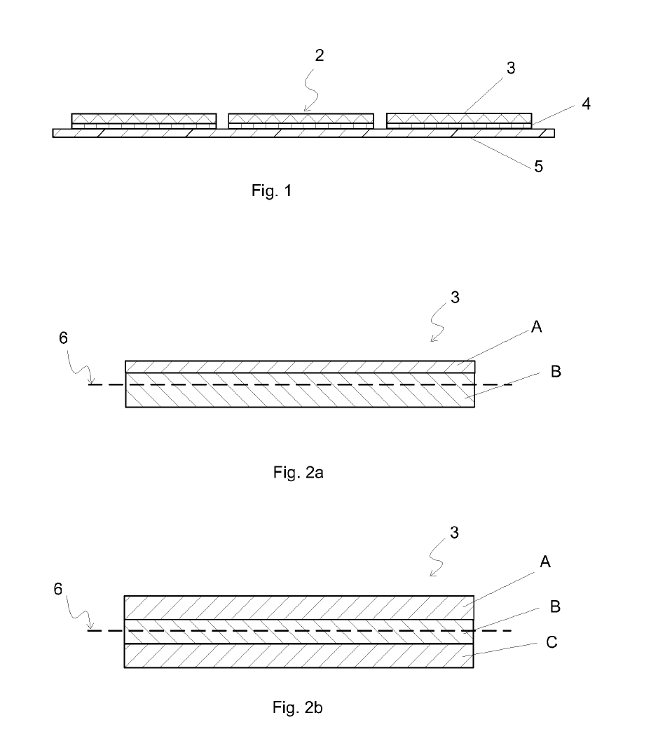

FIG. 1 shows a web comprising labels 2. The label 2 comprises a base film 3 and an adhesive layer 4. Underneath the labels 2, there is a release surface, such as a release paper 5, or a release film.

The base film 3 of the label may also be directly printed, or a pre-printed film may be laminated over the base film of the label. In other words, the structure of the label 2 can also comprise a print layer on the top surface of the base film 3 and a transparent protective layer overlying the print layer.

In the following, the base film structures according to the invention will be described in detail.

### The First Embodiment of the Invention

FIGS. 2a and 2b show a cross-sectional view of the base film 3 of the label according to the first embodiment of the invention. The base film 3 is a co-extruded multilayered film, i.e. a non-laminated film, which comprises at least two layers, which layers are composed of different chemical compositions, and the layers are formed in such a way that the base film 3 formed by the layers is asymmetrical.

As illustrated in FIGS. 2a and 2b, the structure of the base film 3 is asymmetrical with respect to the longitudinal central axis 6 of the base film formed by the layers. The term “asymmetrical” means that the materials used in the layers of the label are different on the different sides of the central axis 6. This means that the layers are formed in such a way that the asymmetrically structured multilayered base film 3 results.

The asymmetry of the base film 3 can be achieved in several different ways via altering the thickness of the individual layers and/or the order of the different material layers of the film.

FIG. 2a presents one asymmetrical base film structure according to the first embodiment of the invention. The base film 3 comprises two layers which are coextruded. The layers are made of different materials A and B, and the layers have a different thickness. Due to the different thicknesses of the layers, the structure of the base film 3 is asymmetrical with respect to the longitudinal central axis 6 of the base film. One side of the base film 3 comprises only material A, and the other side comprises both material A and material B.

FIG. 2b presents another asymmetrical base film structure according to the first embodiment of the invention. The base film 3 is a three-layer film comprising outer layers and an inner layer. The materials of the layers (A, B and C) are selected so that the structure of the multilayered label will be asymmetrical, i.e. the material of the outmost layer on the top surface of the inner layer is different from the material of the outmost layer on the lower surface of the inner layer. In this case the thicknesses of the individual layers may be the same or different.

The base film 3 can also comprise more than three layers in such a way that the order of the different material layers in the film provides the required asymmetry. In the case of more than three layers, asymmetry can also be enhanced by the fact that the individual layers have different thicknesses.

This solution of the invention comprises the use of an asymmetrical base film in the pressure-sensitive construction. In this case, a silicone-coated release-liner is coated with, for example, an acrylic adhesive and laminated to a multilayered asymmetrical base film. Typically, the multilayered films used in labels are symmetrical, that is the outside or skin layers are virtually the same, allowing the films to be easily produced and wound-up and delivered without curling which could cause processing difficulties in resultant processes. Typically such films have a layer make-up of either A/B/A or A/B/C/B/A. In the first embodiment of the invention, the base film comprises the asymmetrical layer make-up as presented above.

The base film 3 being the top surface of the pressure-sensitive structure may be either surface printed or alternatively laminated together with a reverse-printed film such as polypropylene. In this case, either the base film or a combination of such a base film overlaminated with another polypropylene film, has a density lower than one and can be easily separated from the polyester bottles in the recycling process.

The layers of this asymmetrical film may be composed of any of the following chemical composition: polyethylene, polypropylene, cyclic polyolefin, cyclic olefin polymer, cyclic olefin copolymer, polystyrene, ethylene vinyl alcohol or other ethylene copolymers, or propylene copolymers.

Preferably, the base film 3 comprises one polypropylene layer and one polystyrene layer, which layers have different thicknesses.

The layers of the base film 3 according to the first embodiment of the invention can also be oriented monoaxially or biaxially. If the base film is biaxially oriented, it can be oriented with equal or different ratios in the machine direction MD and the cross direction CD.

Under the action of the hot-alkaline washing process, this asymmetrical base film will curl severely, causing it either alone or in combination with another overlamination film to be washed off the bottle and to float to the surface of the liquid, where the labels can be easily removed.

### The Second Embodiment of the Invention

The second embodiment of the invention utilises the fact that significant stresses are caused when at least two films of significantly different degrees of orientation are laminated to each other and subjected to the heat present in the normal bottle washing conditions of 65 . . . 85° C. in an alkaline solution.

In this embodiment, the films may have an identical chemical composition, differing only in the direction of orientation. The layers can be composed of any material that can be oriented, but preferably layers are composed of polypropylene.

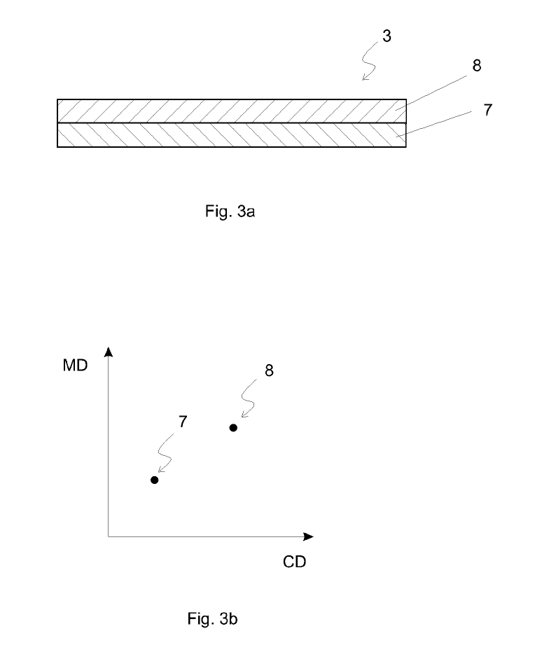

FIGS. 3a and 3b illustrate the base film 3 of the label according to the second embodiment of the invention. FIG. 3a shows a cross-sectional view of the base film 3 of the label according to the second embodiment of the invention. The base film 3 comprises at least two layers 7, 8 which are oriented in different degrees of orientation in at least one direction of the layer. In other words, the oriented and heat stabilized layers of the base film are made of the same polymer type with a different E-modulus in at least one of the directions (MD, CD) of the layers. One of the layers can also be non-oriented. FIG. 3b illustrates a different degrees of orientation of the layers.

The base film 3 comprises preferably two layers, but it is possible that it comprises more than two layers that are oriented in different degrees of orientation in at least one direction of the layer.

The layers can also be biaxially oriented in such a way that the layer has a different degree of orientation in the machine direction (MD) and the cross direction (CD).

The base film 3 according to the second embodiment of the invention consists of an oriented layer, preferably being of cast stenter but alternatively blown in origin. The first layer is overlaminated with another oriented layer, of preferably blown but alternatively stenter in origin. The base film structure can alternatively comprises two blown or two stenter layers with different degrees of orientation in MD and CD.

In this embodiment, a release liner, typically a polyester liner is coated with silicone and cured under heat, after which it is coated with an adhesive. This is preferentially an acrylic adhesive and could be emulsion-based or UV-hot-melt-based. A polypropylene film of 15 to 60 microns, preferably 20 to 30 microns, is laminated to the above structure which causes the adhesive to transfer to the polypropylene film. The polypropylene film in this case is preferably a cast stenter film with a typical orientation in the machine and cross directions of approximately five times. Alternatively, the film may be a blown film.

A second polypropylene film, of 15 to 60 microns, preferably 20 to 30 microns in thickness, is printed and then laminated to the base pressure-sensitive structure described above. The polypropylene film used as the overlaminating film is preferably a blown film with a typical orientation in the machine and cross directions of approximately eight times. This is a significant difference in the degrees of orientation and its asymmetrical drop in E-modulus which induces the stress on the self-adhesive that causes the laminated structure to separate when subjected to heat conditions of the washing solutions. As the self-adhesive does not form any covalent bonds, the hot alkaline solution weakens its adhesion and the stress causes the label to detach from the bottle. Alternatively, the second film may be a stenter film.

Such a polypropylene/polypropylene structure described above has not only the significant benefit compared with previously used structures in that it is simpler and more cost efficient than such alternatives, but it also solves the major drawback of previously used structures in that this new solution has a density lower than one. Therefore, it can not only be washed and separated from glass bottles, but it can also be washed and separated from polyester bottles. The polyester recycling process requires that the label separates from the bottle, either in whole or in pre-crushed form, and then floats to the surface of the solution. The polyester conversely sinks to the bottom of the solution. In this way, both the polypropylene label and the polyester can be recovered and recycled. This is not possible with the alternative solutions described above, as their densities are greater than one and they sink together with the polyester and cannot be separated from it.

The invention is not restricted to the examples of the above description, but it can be modified within the scope of the inventive idea presented in the claims.

1-17. (canceled)

18. A label, comprising:
a base film having a front side and a reverse side; and
an adhesive layer on the reverse side of the base film,
wherein the base film comprises a co-extruded multilayered film comprising at least two layers, wherein the two layers comprise different chemical compositions, and wherein the two layers are formed such that the base film formed by the layers has an asymmetry.

19. The label according to claim 18, wherein the asymmetry is provided by at least one layer having a thickness different from the other layer(s).

20. The label according to claim 18, wherein the base film comprises at least three layers, and wherein the asymmetry is provided by an order of the layers, at least two layers being made of different materials.

21. The label according to claim 20, wherein the asymmetry is further enhanced by at least one layer having a thickness different from the other layer(s).

22. The label according to claim 18, wherein the layer comprises any of the following chemical compositions: polyethylene, polypropylene, cyclic polyolefin, cyclic olefin polymer, cyclic olefin copolymer, polystyrene, ethylene vinyl alcohol or other ethylene copolymers, or propylene copolymers.

23. The label according to claim 18, wherein the base film is oriented in at least one direction of the film.

24. The label according to claim 23, wherein the base film is biaxially oriented in such a way that the base film has a different degree of orientation in a machine direction and a cross direction.

25. The label according to claim 18, further comprising:
a print layer on the top surface of the base film.

26. The label according to claim 25, further comprising:
a transparent protective layer overlying the print layer.

27. The label according to claim 18, further comprising:
a container on which the label is applied.

28. A label, comprising:
a base film having a front side and a reverse side; and
an adhesive layer on the reverse side of the base film,
wherein the base film comprises a multilayered film comprising at least two layers laminated together, which layers are oriented in different degrees of orientation in at least one direction of the layer.

29. The label according to claim 28, wherein at least one layer is biaxially oriented in such a way that the layer has a different degree of orientation in the machine direction and the cross direction.

30. The label according to claim 28, wherein the chemical compositions of the differently oriented layers are substantially the same.

31. The label according to claim 28, wherein the layers are composed of polypropylene.

32. The label according to claim 28, further comprising:
a print layer on the top surface of the base film.

33. The label according to claim 32, further comprising:
a transparent protective layer overlying the print layer.

34. The label according to claim 28, further comprising:
a container on which the label is applied.

35. A method for providing wash-off pressure-sensitive labels for bottles and other containers, the method comprising:
providing a multi-layered base film by co-extruding at least two layers having different chemical compositions, wherein the two layers are formed such that the base film formed by the layers has an asymmetry, the base film having a front side and a reverse side; and
providing an adhesive layer on the reverse side of the base film.

36. The method according to claim 35, wherein the label is formed on a container or applied to the container.

37. A method for providing wash-off pressure-sensitive labels for bottles and other containers, the method comprising:
providing a multilayered base film by laminating together at least two layers oriented in different degrees of orientation in at least one direction of the layer, the base film having a front side and a reverse side; and
providing an adhesive layer on the reverse side of the base film.

38. The method according to claim 37, wherein the label is formed on a container or applied to the container.
